(19) United States
(12) Patent Application Publication
(10) Pub. No.: US 2014/0325933 A1
(43) Pub. Date: Nov. 6, 2014

(54) SAFETY DEVICE, METHOD FOR MANUFACTURING SAID SAFETY DEVICE AND METHOD FOR SAFELY INSTALLING A SERVICE ELEMENT PASSING THROUGH AN APERTURE

(71) Applicants: Fausto Marcigot, Tyrone (GB); Ross Vickers, Gainsborough (GB)

(72) Inventors: Fausto Marcigot, Tyrone (GB); Ross Vickers, Gainsborough (GB)

(73) Assignee: Oxford Plastic Systems Limited, Oxfordshire (GB)

(21) Appl. No.: 14/239,495

(22) PCT Filed: Aug. 16, 2012
(86) PCT No.: PCT/EP2012/065993

§ 371 Date: Jul. 14, 2014

(30) Foreign Application Priority Data
Aug. 18, 2011 (IT) USD2011A000131

(51) Int. Cl. E04G 21/32; F16L 5/00

(52) U.S. Cl. CPC E04G 21/32; F16L 5/00
USPC 52/741.1; 16/2.1

(57) ABSTRACT

A safety device (10) is applicable in association with an aperture (20) made in a floor (22), or work, support or bearing plane, through which a service element (12, 14, 16) passes with a substantially longitudinal development, such as a pipe, tube, cable-conduit and suchlike. The safety device (10) is usable to completely close the empty space defined between the peripheral edges (18) of said aperture (20) and the transverse bulk of said service element (12, 14, 16). The safety device (10) is formed by a plurality of modular sections (24, 26) to define a base body (11), suitable to completely surround said service element (12, 14, 16), which functions as a closing barrier of said empty space and which can be configured to define an internal passage (76, 78, 80) in order to house the service element (12, 14, 16) to size.

This application is entitled to the benefit of, and incorporates by reference essential subject matter disclosed in PCT Application No. PCT/EP2012/065993 filed on Aug. 16, 2012, which claims priority to Italian Application No. USD2011A000131 filed Aug. 18, 2011.

### BACKGROUND OF THE INVENTION

1. Technical Field

The present invention concerns a safety device, which supplies a mechanical protection against, to give a non-restrictive example, the fall of service elements such as pipes, tubes, cable-conduits raceway and suchlike, to transport fluids or to contain other devices, such as electric cables, power lines, fluid-dynamic tubes or suchlike, which, passing through a suitable aperture, cross a floor or a work, support or bearing plane, in industrial environments, without excluding possible domestic applications. The present invention further concerns a method for manufacturing said safety device and a method for safely installing a service element passing through an aperture.

2. Background Information

It is known that, for the passage of service elements such as pipes, tubes, cable-conduits and suchlike, through a floor or a work, support or bearing plane, it is necessary to provide an aperture which, with respect to the bulk of the service element, defines an empty space which surrounds it.

It is also known that, in both the industrial and domestic field, there is the possibility of falling both for people, who can trip or take a false step because of said aperture, and for objects, which can be heavy and dangerous, such as work tools, which can inadvertently fall through said empty space which surrounds the service element, causing accidents, even serious ones, to people.

One known solution is to weld a vertical barrier or plate around the aperture to completely surround the empty space, with the purpose of solving the above drawbacks. However, this solution has proved to be only partial, in that it does not guarantee the complete safety of the apertures, both in terms of safety for the passage of people and in terms of falling objects.

Document US-A-2006/027388 discloses a known flashing kit for sealing or waterproofing a hole in a wall with a conduit penetrating therethrough.

Document U.S. Pat. No. 7,010,889 discloses a riser support clamp for pipe riser or conduit. Purpose of the present invention is to make a safety device which guarantees complete closing of the empty spaces associated to the apertures through which the above service elements pass.

A further purpose is to provide a method for manufacturing said safety device and a method for safely installing a service element passing through an aperture. The Applicant has devised, tested and embodied the present invention to overcome the shortcomings of the state of the art and to obtain these and other purposes and advantages.

### SUMMARY OF THE DISCLOSURE

The present invention is set forth and characterized in the independent claims, while the dependent claims describe other characteristics of the invention or variants to the main inventive idea.

In accordance with the above purposes, a safety device according to the present invention is applied in association with an aperture made in a floor, or in a work, support or bearing plane, through which a service element with a substantially longitudinal, or axial, development passes, such as a pipe, tube, cable-conduit raceway and suchlike.

The safety device of the present invention can be used to completely close an empty space defined between peripheral edges of said aperture and a transverse bulk of said service element, in this way preventing the accidental fall of objects through the empty space, guaranteeing safety.

The safety device of the present invention is formed by a plurality of modular sections, configured to be located around the service element adjacently positioned each other to define, in an assembled condition, a base body suitable to completely cover said aperture and to surround, in said assembled condition, the service element passing through said aperture in its assembled condition.

The base body functions, in said assembled condition, as a closing barrier of the empty space and can be configured to define an internal passage in order to house the service element to size, so that substantially there are no dangerous cracks or spaces remaining. The base body is configured shaping said modular sections by removing portions of the material of the modular sections such that said modular sections are adapted to the dimensions of the service element to be surrounded by said modular sections. The base body is mating with and is larger in size than the aperture, so that it can be stably positioned resting on the edges thereof, on the corresponding floor, work, support or bearing plane.

The overall sizes of the base body are designed big enough to completely cover the aperture, including the empty space delimited between the peripheral edges of said aperture and the transverse bulk of said service element, and to overlap the floor, work, support or bearing plane, so as to rest safely thereon.

In one form of embodiment, the modular sections of the safety device in question have a first open condition, in which they are separated or distanced so that they can be located around the service element, and a second closed or assembled position, in which the modular sections are coupled so as to completely surround the service element and define the internal through seating in which the service element is housed.

In one form of embodiment, the modular sections can be shaped by removing one or more desired portions of material, so as to achieve, on each occasion and according to the service element to be surrounded in order to close the corresponding empty space, the internal passage to house the service element to size.

In an advantageous variant, the modular sections comprise a first adapter element that can be shaped by removing a desired quantity of material, so as to define the passage to house the service element to size, and a second barrier element, outside the first adapter element, in order to close the empty space as above.

Advantageously, the modular sections in question are of a substantially planar shape, able to be coupled with each other lying on a parallel or coincident lying plane to that of the floor, work, support or bearing plane through which the service element passes.

In variant embodiments attachment means are provided, releasable or definitive, to reciprocally constrain the modular sections of the base body of the safety device in the closed condition.

In further variants, other mechanical connection means are provided to constrain the safety device to the floor, work, support or bearing plane. In other variants, the safety device may not be constrained to the floor, work, support and bearing plane, so as to be free to move slightly, remaining however disposed around the service element and without determining dangerous spaces, if the service element vibrates.

It comes also within the spirit of the present invention a method for manufacturing a safety device applicable in association with an aperture made in a floor, a work, support or bearing plane, through which a service element passes with a substantially longitudinal development, such as a pipe, tube, cable-conduit and suchlike Said safety device is usable to completely close an empty space defined between peripheral edges of said aperture and a transverse bulk of said service element. The method provides to form said safety device by means of a plurality of modular sections configured to be located around the service element, adjacently positioned each other to define, in an assembled condition, a base body, to completely cover said aperture and to surround, in said assembled condition, said service element passing through said aperture.

The base body functions, in said assembled condition, as a closing bather of said empty space, and is configured to define an internal passage in order to house the service element to size. The base body is configured shaping said modular sections by removing portions of the material of the modular sections such that said modular sections are adapted to the dimensions of the service element to be surrounded by said modular sections.

It is a further aspect of the present invention a method for safely installing a service element passing with a substantially longitudinal development, such as a pipe, tube, cable-conduit and suchlike, through an aperture made in a floor, a work, support or bearing plane, by completely closing an empty space defined between peripheral edges of said aperture and a transverse bulk of said service element.

The method provides:
to use a plurality of modular sections defining, in an assembled condition, a base body, completely covering said aperture,
to define an internal passage trough the base body defined by said modular sections in order to house the service element to size, shaping said modular sections by removing portions of the material of the modular sections such that said modular sections are adapted to the dimensions of the service element to be surrounded by said modular sections and to assemble said base body functions, to obtain a closing barrier of said empty space,
to locate said modular sections around the service element, adjacently positioned each other to define said base body, surrounding, in said assembled condition, said service element passing through said aperture and through said internal passage.

### BRIEF DESCRIPTION OF THE DRAWINGS

These and other characteristics of the present invention will become apparent from the following description of some forms of embodiment, given as a non-restrictive example with reference to the attached drawings wherein:

FIG. 1 is a perspective view in separate parts of a safety device according to the present invention in a first open condition;

FIG. 2 is a perspective view of the safety device in FIG. 1 in a second closed condition;

FIG. 3 is a perspective view of a component of a part of a safety device in FIG. 1;

FIG. 4 is a perspective view of two coupled components of FIG. 3;

FIG. 5 is a perspective view of two components of FIG. 3 coupled in a first application used for the passage of a tubular service element;

FIG. 6 is a perspective view of two components of FIG. 3 coupled in a second application used for the passage of two pipes;

FIG. 7 is a perspective view of two components of FIG. 3 coupled in a third application used for the passage of a cable-conduit raceway;

FIG. 8 is a perspective view of the safety device in FIG. 1 of the first application of FIG. 5, in the first open condition;

FIG. 9 is a perspective view of the safety device in FIG. 1 of the first application of FIG. 5, in the second closed condition;

FIG. 10 is a perspective view of the present invention of the second application in FIG. 6, in the first open condition;

FIG. 11 is a perspective view of the present invention of the second application in FIG. 6, in the second closed condition;

FIG. 12 is a perspective view of the present invention of the third application in FIG. 7, in the first open condition;

FIG. 13 is a perspective view of the present invention of the third application in FIG. 7, in the second closed condition.

To facilitate comprehension, the same reference numbers have been used, where possible, to identify identical common elements in the drawings. It is understood that elements and characteristics of one form of embodiment can conveniently be incorporated into other forms of embodiment without further clarifications.

### DETAILED DESCRIPTION OF THE INVENTION

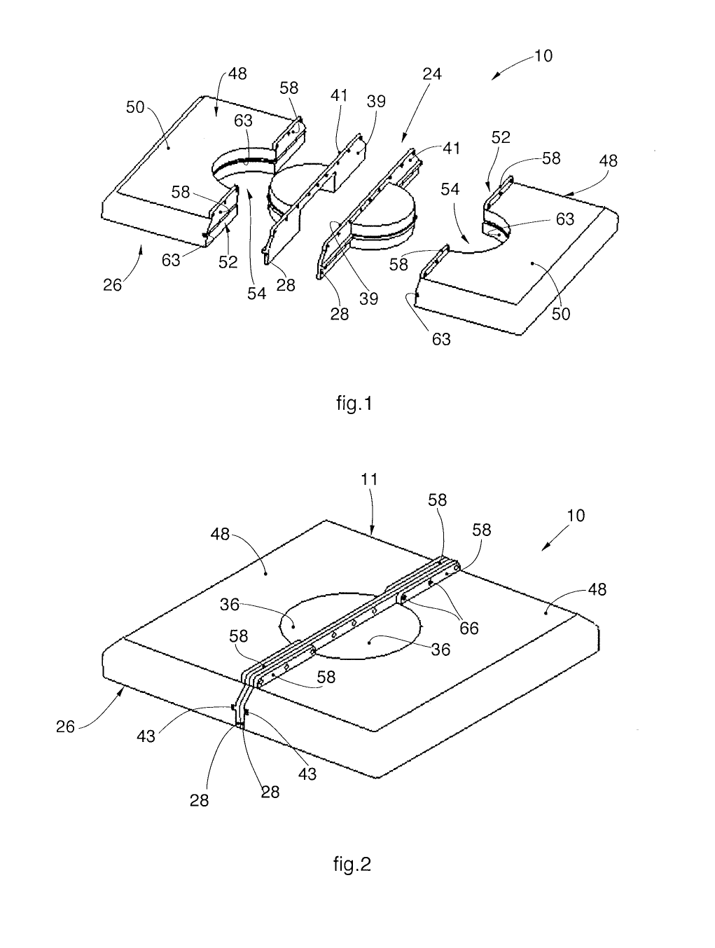

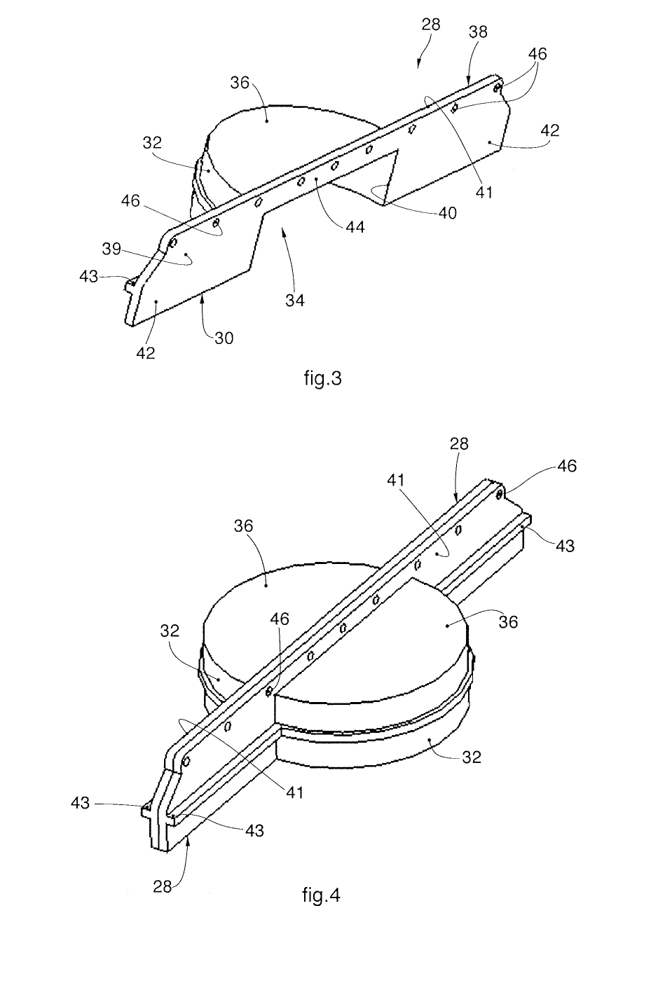

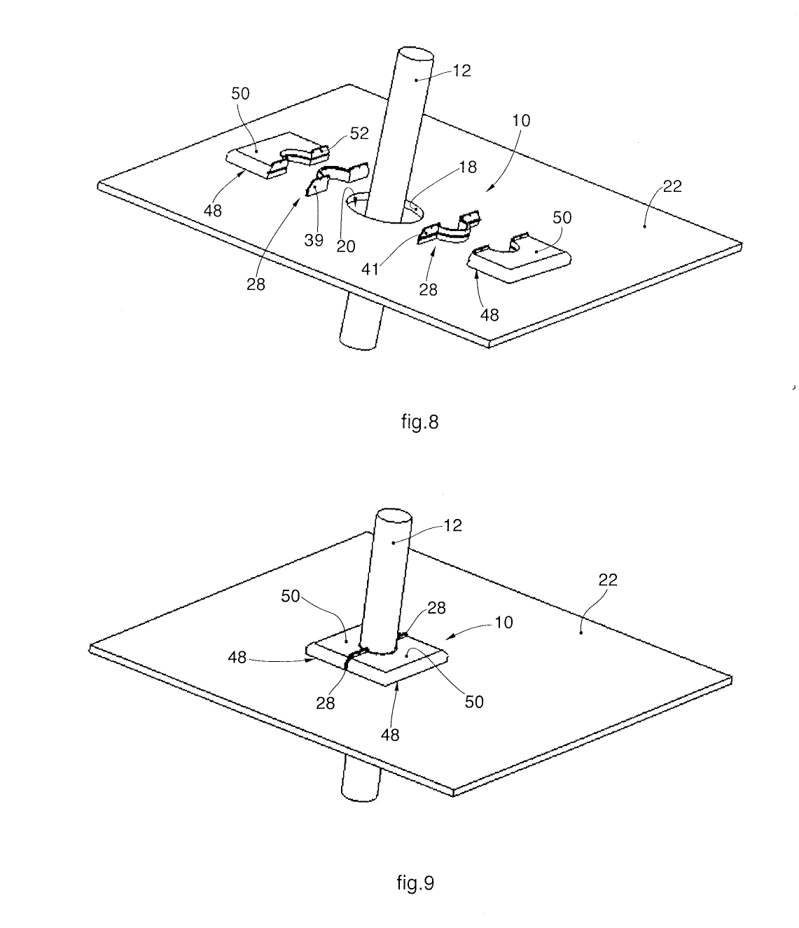

With reference to FIG. 1, a safety device 10 according to the present invention can be used to define a covering, or closure of the empty space between an oblong element, such as a tubular service element 12, a pair of pipes 14, a through cable-conduit raceway 16, and the edges 18 of a through aperture 20 made on a support or bearing plane 22, such as a grill plane or similar plane, for example which functions as a walkway, also elevated, in industrial plants and suchlike, through which aperture 20 the oblong element passes (FIGS. 8-13).

The device 10 comprises a base body 11 formed by a plurality of modular sections, of which, in this case, at least a first central adapter element 24, which can be configured to allow the passage of said oblong element, and a second barrier element 26, which peripherally surrounds the first adapter element 24, sized in a way so as to define, an effective and reliable closure of the aperture 20, preventing the passage or fall of objects and thus guaranteeing safety.

The first adapter element 24 is formed by a pair of first semi-elements 28 of an identical shape.

The second barrier element 26 is formed by a pair of second semi-elements or semi-shells 48, identical in shape and which can be coupled with each other as shown in FIGS. 2, 9, 11, 13.

With reference to the first adapter element 24, each of the first semi-elements 28 comprises a shaped frame 30, made of plastic, metal or suchlike, comprising a first central concave wall 32, which defines a first housing space 34 able to contain the oblong element and which is associated to a second wall 36 transverse to the first central concave wall 32 and disposed to close the first housing space 34 at the upper part, in correspondence to the top edge of the first central concave wall 32. The second wall 36 is made of material which can be shaped, plastic, metal or suchlike, by the user, in such a way as to adapt it, creating suitable windows, passages and apertures, to contain the desired oblong passage element to be housed, as explained in more detail hereafter in conjunction with FIGS. 8-13. The shaped frame 30 also comprises a third attachment wall 38, made of plastic, metal or suchlike, from which the central concave first wall 32 centrally projects.

The third wall 38 of each first semi-element 28 functions as a first connection flange, cooperating with an equal third wall 38 of another first semi-element 28 to be connected (FIGS. 4-7).

The third wall 38 is also made of a material which can be shaped by the user, such as plastic, metal or suchlike, so as to adapt it, creating suitable windows, passages and apertures, in a similar way to that of the transverse second wall 36 associated to the first central concave wall 32.

In this case, the third wall 38 has a central passage 40, with a width substantially equal to that of the first housing space 34, defining two lateral segments 42 of the third wall 38, with a height slightly higher than the first central concave wall 32 and a central segment 44 which overlaps the central passage 40, connecting the two lateral segments 42. The first central concave wall 32 connects the lateral edges of the central passage 40 of the third wall 38.

The third wall 38 has a first face 39 able to be put adjacent to a corresponding first face 39 of the third wall 38 of a similar first semi-element 28, in the closed condition, and a second face 41 able to be put adjacent to a corresponding second semi-element 48 of the second barrier element 26, again in the closed condition. The upper edge of the third wall 38 has first housing holes 46 for attachment means to constrain the two first semi-elements 28 in a closed condition of the device 10 (FIGS. 4-7, 9, 11, 13).

Moreover, in this case, the third wall 38 of each first semi-element 28 has, on the second face 41, a ridge 43 which acts as both a lead-in element and as a holding element, in positioning each first semi-element 28 in association to the corresponding second semi-element 48.

With reference to the second barrier element 26, each second semi-element 48 which makes it up comprises a fourth barrier wall 50 of a correlated part of the aperture 20 (FIG. 1), which has a lateral edge 52 able to cooperate, in the closed condition, with the second face 41 of a corresponding first semi-element 28 adjacent to it.

On the lateral edge 52, centrally, a second housing space 54 is made, of a shape mating with the first central concave wall 32 of a corresponding first semi-element 28, so as to house the latter inside it in the closed condition. On the lateral edge 52, laterally to the second housing space 54, fifth attachment walls 58 are provided, made of plastic, metal or suchlike, which act as second connection flanges, cooperating both with the pairs of third walls 38 of the connected first two semi-elements 28, and with the identical fifth walls 58 of another second semi-element 48 to be connected. The upper edge of the fifth walls 58 has second housing holes 66 for attachment means to constrain the two second semi-elements 48 in a closed condition of the device 10 (FIGS. 4-7, 9, 11, 13).

The lateral edge 52 has a groove, or notch 63 (FIG. 1) of a shape mating with the ridge 43 and able to cooperate with it, acting as a guide, or insertion lead-in, and as a holding seating in positioning each first semi-element 28 in association to the corresponding second semi-element 48.

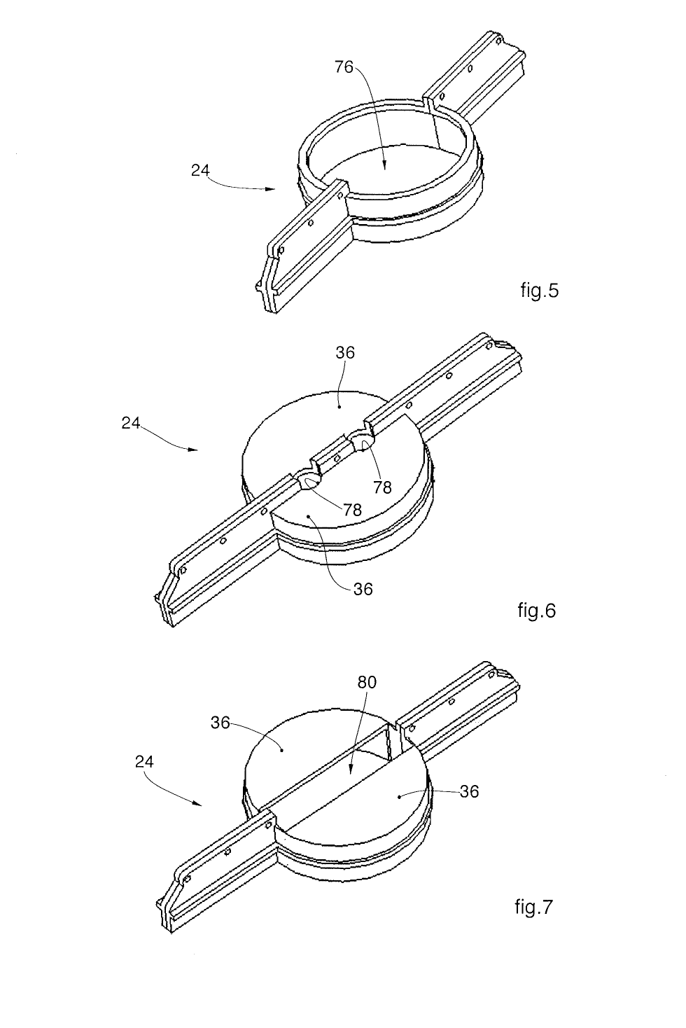

FIGS. 8 and 9 show, respectively in an open and closed condition, a first application of the device 10 in which the second wall 36 of each first semi-element 28, as well as the corresponding central segment 44 of the third wall 38, are completely removed to create a suitable passage window 76 (FIG. 5) for a tubular service element 12. In this first application it shows, by way of example, how if there is an aperture 20 of a regular shape, in this case circular, the fourth wall 50 of each second semi-element 48 determines an efficient and complete closing of the aperture 20 in the closed condition, preventing the accidental fall of objects.

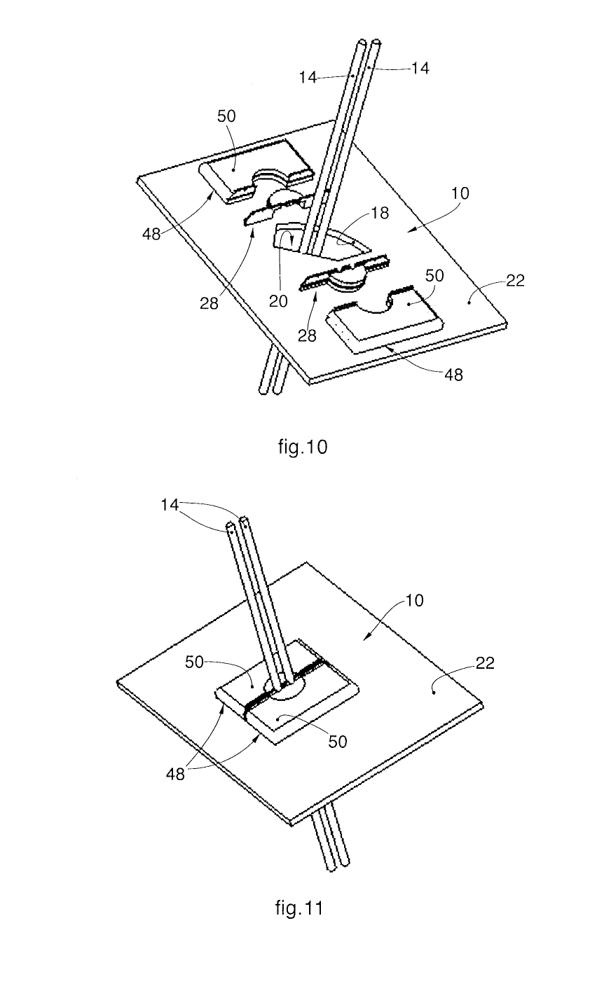

FIGS. 10 and 11 show, respectively in an open and closed condition, a second application of the device 10 in which the second wall 36 of each first semi-element 28, as well as the corresponding central segment 44 of the third wall 38, are only partly shaped, by removing suitable portions of material to define two passage holes 78 (FIG. 6) for the passage of a pair of pipes 14. The second application shows, by way of example, how if there is an aperture 20 of an irregular shape, the fourth wall 50 of each second semi-element 48 determines, in any case, an efficient and complete closing of the aperture 20 in the closed condition, preventing the accidental fall of objects.

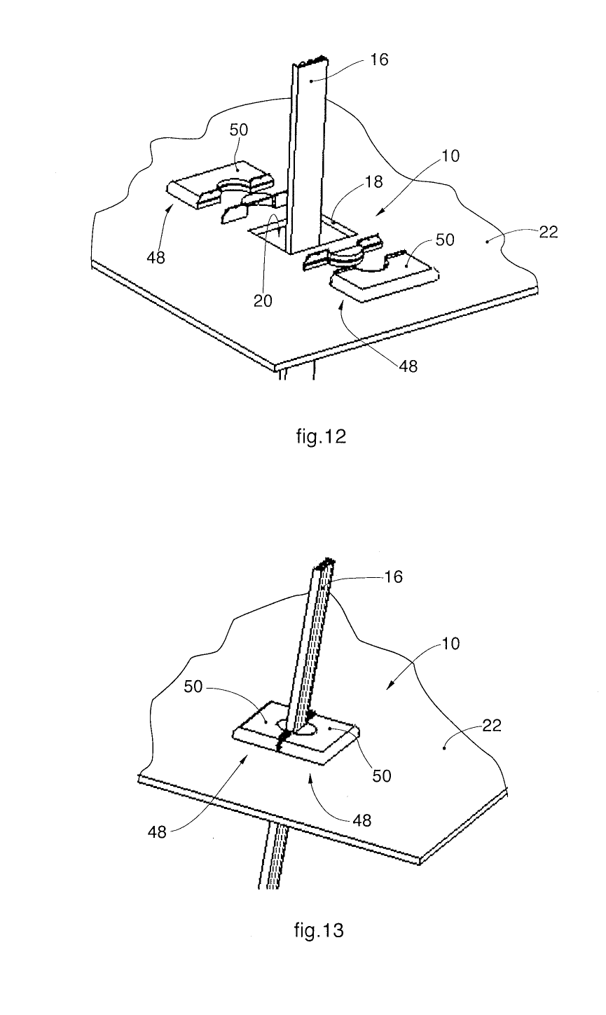

FIGS. 12 and 13 show, respectively in an open and closed condition, a third application of the device 10 in which the second wall 36 of each first semi-element 28 is only partly shaped, by removing suitable portions of material, and in which the corresponding central segment 44 of the third wall 38 is removed, to define a crack 80 (FIG. 7) for the passage of a cable-conduit raceway 16. The third application shows, by way of example, how if there is a rectangular aperture 20, the fourth wall 50 of each second semi-element 48 determines, in any case, an efficient and complete closing of the aperture 20 in the closed condition, preventing the accidental fall of objects.

Whilst specific embodiments of the invention are described herein, it will be appreciated that a wide range of modifications and alterations may be made to the arrangements described and illustrated without departing from the scope of the invention.

What is claimed is:

1-12. (canceled)

13. A safety device for closing an aperture in a support surface, wherein the safety device is formed by a plurality of modular sections comprising:
a first outer shell having a first edge in which there is provided a first recess;
a second outer shell having a second edge in which there is provided a second recess;
a first adapter portion received in the first recess; and
a second adapter portion received in the second recess;
wherein the first and second outer shells are connected together with the first edge of the first outer shell facing the second edge of the second outer shell so as to define a base plate which rests on the support surface around said aperture, the first recess and the second recess are aligned, and the first adapter portion and the second adapter portion form an adapter which closes the aperture.

14. The safety device as claimed in claim 13, wherein an elongate service element passes through the aperture in the support surface and the adapter closes an empty space defined between the periphery of the aperture and the service element, the adapter having a passage through which the service element passes, and the adapter being disposed closely around the service element.

15. The safety device as claimed in claim 14, wherein the passage is defined by a first cut away portion on the first adapter portion, which is closed by the second adapter portion.

16. The safety device as claimed in claim 14, wherein the passage is defined by a first cut away portion on the first adapter portion, which is aligned with and cooperates with a second cut away portion on the second adapter portion.

17. The safety device as claimed in claim 13, wherein the first recess is semi-circular, the second recess is semi-circular, the first adapter portion is semi-circular and the second adapter portion is semi-circular.

18. In combination, a support surface having an aperture, an elongate service element which passes through the aperture in the support surface, and a safety device which closes an empty space defined between the service element and the periphery of the aperture, wherein the safety device is formed by a plurality of modular sections comprising:
a first outer shell having a first edge in which there is provided a first recess;
a second outer shell having a second edge in which there is provided a second recess; a first adapter portion received in the first recess; and
a second adapter portion received in the second recess;
wherein the first and second outer shells are connected together with the first edge of the first outer shell facing the second edge of the second outer shell so as to define a base plate which rests on the support surface around said aperture, the first recess and the second recess are aligned, and the first adapter portion and the second adapter portion form an adapter having a passage through which the service element passes, the adapter being disposed closely around the service element.

19. The combination as claimed in claim 18, wherein the passage is defined by a first cut away portion on the first adapter portion, which is closed by the second adapter portion.

20. The combination as claimed in claim 18, wherein the passage is defined by a first cut away portion on the first adapter portion, which is aligned with and cooperates with a second cut away portion on the second adapter portion.

21. The combination as claimed in claim 18, wherein the first recess is semi-circular, the second recess is semi-circular, the first adapter portion is semi-circular and the second adapter portion is semi-circular.

22. A method of placing a safety device around an elongate service element which extends through an aperture in a support surface, so as to close an empty space defined between the service element and the periphery of the aperture, the safety device being formed by a plurality of modular sections and comprising a first outer shell having a first edge in which there is provided a first recess; a second outer shell having a second edge in which there is provided a second recess; a first adapter portion received in the first recess; and a second adapter portion received in the second recess; wherein the first and second outer shells are placed on either side of the service element; the first adapter portion and the second adapter portion are placed on either side of the service element, the first and second outer shells are connected together with the first edge of the first outer shell facing the second edge of the second outer shell so as to define a base plate which rests on the support surface around said aperture, and the first recess and the second recess are aligned; the first adapter portion and the second adapter portion forming an adapter having a passage through which the service element passes, the adapter being disposed closely around the service element.

23. The method as claimed in claim 22, wherein the passage is defined by a first cut away portion on the first adapter portion, which is closed by the second adapter portion.

24. The method as claimed in claim 22, wherein the passage is defined by a first cut away portion on the first adapter portion, which is aligned with and cooperates with a second cut away portion on the second adapter portion.

25. The method as claimed in claim 22, wherein the first recess is semi-circular, the second recess is semi-circular, the first adapter portion is semi-circular and the second adapter portion is semi-circular.
